(19) United States
(12) Patent Application Publication
(10) Pub. No.: US 2008/0225463 A1
(43) Pub. Date: Sep. 18, 2008

(54) LAYERED CAPACITOR AND MOUNTING STRUCTURE

(75) Inventors: Hirokazu Takashima, Nagaokakyo-shi (JP); Hiroshi Ueoka, Nagaokakyo-shi (JP); Yoshikazu Takagi, Nagaokakyo-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: MURATA MANUFACTURING CO., LTD., Nagaokakyo-shi (JP)

(21) Appl. No.: 12/124,325

(22) Filed: May 21, 2008

Related U.S. Application Data
(63) Continuation of application No. PCT/JP2006/322708, filed on Nov. 15, 2006.

(30) Foreign Application Priority Data
Dec. 1, 2005 (JP) 2005-347655

(51) Int. Cl. H01G 4/232

(52) U.S. Cl. 361/306.3

(57) ABSTRACT

A layered capacitor includes a capacitor body that is divided into two first capacitor sections and a second capacitor section. The first capacitor sections are disposed at ends in a layer-stacking direction such that the second capacitor section is interposed between the first capacitor sections in the layer-stacking direction. The resonant frequency of the first capacitor sections is greater than that of the second capacitor section. The total number of third internal electrodes and fourth internal electrodes provided per dielectric layer included in the second capacitor section is less than the total number of first via conductors and second via conductors per dielectric layer included in the first capacitor sections. The ESR per dielectric layer included in the second capacitor section is greater than that per dielectric layer included in the first capacitor sections.

### BACKGROUND OF THE INVENTION

1. Field of the Invention

The present invention relates to layered capacitors and mounting structures thereof, and in particular, to layered capacitors used in high-frequency circuits and the mounting structures thereof.

2. Description of the Related Art

Layered capacitors having structures described in, for example, Japanese Unexamined Patent Application Publication No. 11-204372 are known as decoupling capacitors used in power supply circuits, for example, for MPUs (microprocessing units) in high-frequency ranges, such as several gigahertz. In such layered capacitors, a large number of via conductors are provided to connect internal electrodes, and the polarities of two adjacent via conductors are opposite to each other. With this, paths of currents flowing from positive electrodes to negative electrodes can be shortened, and flows of the currents can be diversified. Furthermore, since the directions of the currents are opposite to each other, magnetic fluxes can be canceled, resulting in a reduce ESL (equivalent series inductance).

However, the layered capacitor described in Japanese Unexamined Patent Application Publication No. 11-204372 has a problem that the slope of the impedance characteristic is steep since the ESR (equivalent series resistance) is also reduced with the ESL.

Next, Japanese Unexamined Patent Application Publication No. 2005-203623 describes a layered capacitor capable of maintaining a low impedance in a broad frequency band obtained by arranging a first capacitor section and a second capacitor section having different characteristics in a direction along which layers are stacked in a capacitor body of the layered capacitor so that the characteristics of the first and the second capacitor sections are combined.

However, in the layered capacitor described in Japanese Unexamined Patent Application Publication No. 2005-203623, the overall impedance in a high-frequency range cannot be reduced as shown in FIG. 4 in Japanese Unexamined Patent Application Publication No. 2005-203623 since the resonant frequency of the first capacitor section having a low ESL characteristic is located in a low-frequency range and the resonant frequency of the second capacitor section is located in a high-frequency range.

Next, Japanese Unexamined Patent Application Publication No. 2004-172602 describes a layered capacitor in which a first capacitor section and a second capacitor section are arranged in a capacitor body of the layered capacitor in a direction along which layers are stacked as in the layered capacitor described in Japanese Unexamined Patent Application Publication No. 2005-203623. As is clear from, for example, Paragraph [0016] in Patent Application Publication No. 2004-172602, the number of feed-through conductors (via conductors) provided in the second capacitor section is reduced so that the capacity of the second capacitor section is increased, and the areas of conductive layers (internal electrodes) facing each other are correspondingly increased in this layered capacitor.

However, Japanese Unexamined Patent Application Publication No. 2004-172602 does not describe the idea of increasing the ESR by reducing the number of feed-through conductors. Although Patent Application Publication No. 2004-172602 mentions increasing a frequency range by increasing resistances in Paragraph [0047], the resistances are those of connecting electrodes (3c and 4c) that are connected between feed-through conductors (5a and 5b, and 6a and 6b) shown in FIG. 2.

In Patent Application Publication No. 2004-172602, the capacity of the first capacitor section is less than that of the second capacitor section. The addition of such a first capacitor section having a small capacity to the second capacitor section contradicts a desired result of the invention of increasing the capacity of the second capacitor section as described above.

### SUMMARY OF THE INVENTION

To overcome the problems described above, preferred embodiments of the present invention provide a layered capacitor having a high ESR and a low ESL, and provide a mounting structure with which the low ESL characteristic of a layered capacitor having a low ESL can be advantageously utilized.

A layered capacitor according to a preferred embodiment of the present invention includes a capacitor body having a layered structure including a plurality of stacked dielectric layers, and first, second, third, and fourth external terminal electrodes provided on two main surfaces of the capacitor body.

The capacitor body preferably includes two first capacitor sections and a second capacitor section. The first capacitor sections are located at ends of the capacitor body in a layer-stacking direction and the second capacitor section is interposed between the first capacitor sections in the layer-stacking direction.

Each of the first capacitor sections includes at least a pair of a first internal electrode and a second internal electrode facing each other with one of the dielectric layers interposed therebetween so as to form electrostatic capacitance, first via conductors extending through a desired number of the dielectric layers so as to electrically connect the first internal electrode and the first external terminal electrodes while the first via conductors are electrically insulated from the second internal electrode, and second via conductors extending through a desired number of the dielectric layers so as to electrically connect the second internal electrode and the second external terminal electrodes while the second via conductors are electrically insulated from the first internal electrode.

The second capacitor section preferably includes at least a pair of a third internal electrode and a fourth internal electrode facing each other with one of the dielectric layers interposed therebetween so as to form electrostatic capacitance, third via conductors extending through a desired number of the dielectric layers so as to electrically connect the third internal electrode and the third external terminal electrodes while the third via conductors are electrically insulated from the fourth internal electrode, and fourth via conductors extending through a desired number of the dielectric layers so as to electrically connect the fourth internal electrode and the fourth external terminal electrodes while the fourth via conductors are electrically insulated from the third internal electrode.

The resonant frequency of the first capacitor sections is greater than that of the second capacitor section. Moreover, the total number of the third and fourth via conductors provided per dielectric layer included in the second capacitor section is less than the total number of the first and second via conductors provided per dielectric layer included in the first capacitor sections. Furthermore, the equivalent series resistance per dielectric layer provided by the pair of third and fourth internal electrodes, the dielectric layer interposed therebetween, and the third and fourth via conductors included in the second capacitor section is greater than that per dielectric layer provided by the pair of first and second internal electrodes, the dielectric layer interposed therebetween, and the first and second via conductors included in the first capacitor sections.

In the layered capacitor according to preferred embodiments of the present invention, at least one of the plurality of third via conductors and the plurality of fourth via conductors is preferably directly connected to at least one of the plurality of first via conductors and the plurality of second via conductors so as to be used in common, and at least one of the plurality of third external terminal electrodes and the plurality of fourth external terminal electrodes is preferably at least one of the plurality of first external terminal electrodes and the plurality of second external terminal electrodes.

Moreover, the first and second external terminal electrodes are preferably alternately disposed.

Preferred embodiments of the present invention can be directed to a mounting structure with which the above-described layered capacitor is mounted on a predetermined mounting surface. In the mounting structure of the layered capacitor according to a preferred embodiment of the present invention, the capacitor body is arranged such that one of the first capacitor sections is closer to the mounting surface than the second capacitor section is to the mounting surface.

In the layered capacitor according to preferred embodiments of the present invention, the total number of the first and second via conductors provided per dielectric layer included in the first capacitor sections is greater than the total number of the third and fourth via conductors provided per dielectric layer included in the second capacitor section. With this arrangement, the ESL of the first capacitor sections can be reduced as compared to that of the second capacitor section.

In addition, the ESR per dielectric layer provided by the pair of third and fourth internal electrodes, the dielectric layer interposed therebetween, and the third and fourth via conductors included in the second capacitor section is greater than that per dielectric layer formed by the pair of first and second internal electrodes, the dielectric layer interposed therebetween, and the first and second via conductors included in the first capacitor sections. With this arrangement, the ESR of the second capacitor section can be increased as compared to that of the first capacitor sections.

In the layered capacitor according to preferred embodiments of the present invention, the capacitor body is preferably divided into the two first capacitor sections and the second capacitor section, and the resonant frequency of the first capacitor sections is greater than that of the second capacitor section. With this arrangement, the first capacitor sections affect a high-frequency range in the combined characteristics of the capacitor body, and the ESL characteristic of the first capacitor sections provides a reduction in the ESL of the capacitor body.

Moreover, since the capacitor body is divided into the two first capacitor sections and the second capacitor section, and the resonant frequency of the first capacitor sections and that of the second capacitor section differ from each other, the ESR of the capacitor body is determined by characteristics obtained by combining the ESR of the first capacitor sections and that of the second capacitor section. This provides a high ESR.

As a result, a layered capacitor having both a low ESL and a high ESR is obtained.

Moreover, in the layered capacitor according to preferred embodiments of the present invention, the first capacitor sections are located at ends of the capacitor body in the layer-stacking direction, and the second capacitor section is interposed between the first capacitor sections in the layer-stacking direction. Thus, when the layered capacitor is mounted, paths of currents flowing from positive external terminal electrodes to negative external terminal electrodes via the internal electrodes can be shortened in the first capacitor sections, and the low ESL characteristic achieved by the first capacitor sections can be advantageously utilized. Furthermore, since the second capacitor section is interposed between the two first capacitor sections in the layer-stacking direction and the first to fourth external terminal electrodes are provided on both of the two main surfaces of the capacitor body as described above, the vertical orientation of the capacitor body does not need to be taken into account when providing the mounting structure with which the low ESL is achieved.

In the layered capacitor according to preferred embodiments of the present invention, the connection between the first capacitor sections and the second capacitor section and the connection between the first and second capacitor sections and the first to fourth external terminal electrodes can be simplified when at least one of the plurality of third via conductors and the plurality of fourth via conductors is directly connected to at least one of the plurality of first via conductors and the plurality of second via conductors so as to be used in common, and at least one of the plurality of third external terminal electrodes and the plurality of fourth external terminal electrodes is at least one of the plurality of first external terminal electrodes and the plurality of second external terminal electrodes.

In the layered capacitor according to preferred embodiments of the present invention, paths of currents flowing from positive electrodes to negative electrodes can be further shortened, and magnetic fluxes can be canceled more effectively when the first and second external terminal electrodes are alternately disposed. Thus, the ESL of the first capacitor sections can be further reduced.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a vertical sectional view illustrating the internal structure of a layered capacitor according to a preferred embodiment of the present invention.

FIGS. 2A and 2B are horizontal sectional views illustrating the internal structure of first capacitor sections of the layered capacitor shown in FIG. 1. FIG. 2A is a cross-sectional view at a section where a first internal electrode is located, and FIG. 2B is that at a section where a second internal electrode is located.

FIGS. 3A and 3B are horizontal sectional views illustrating the internal structure of a second capacitor section of the layered capacitor shown in FIG. 1. FIG. 3A is a cross-sectional view at a section where a third internal electrode is located, and FIG. 3B is that at a section where a fourth internal electrode is located.

FIG. 4 illustrates frequency-impedance characteristics of a layered capacitor according to a preferred embodiment of the present invention and a layered capacitor according to a comparative example outside the scope of the present invention including only a first capacitor section and no second capacitor section.

### DETAILED DESCRIPTION OF THE PREFERRED EMBODIMENTS

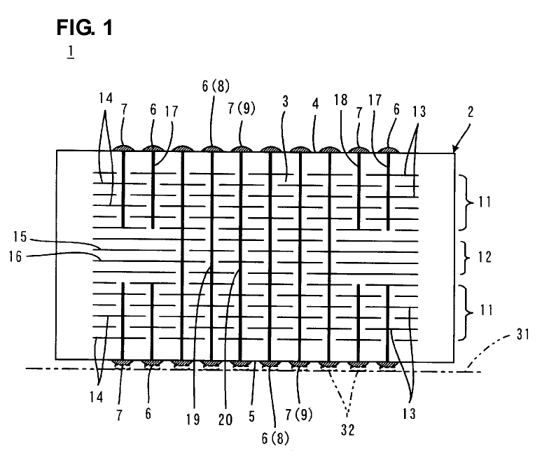

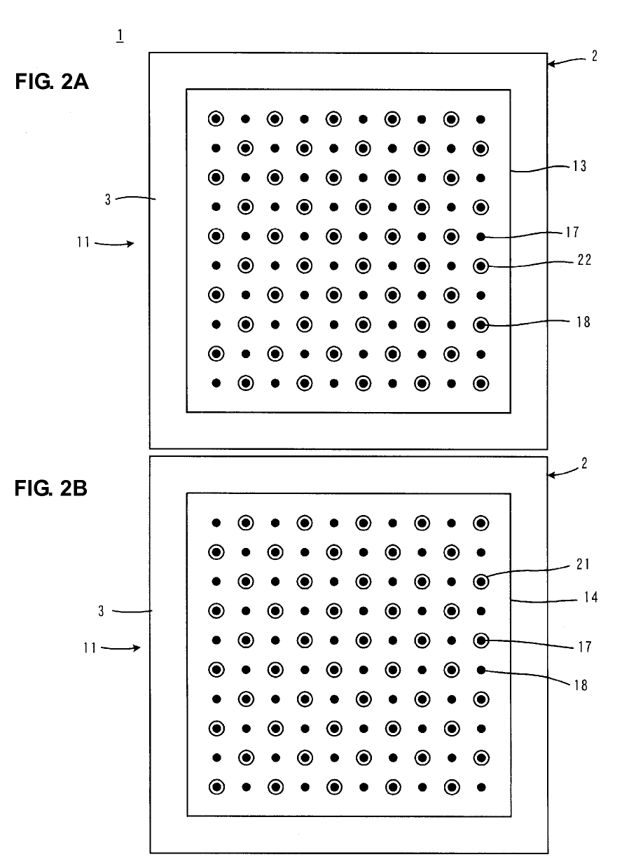

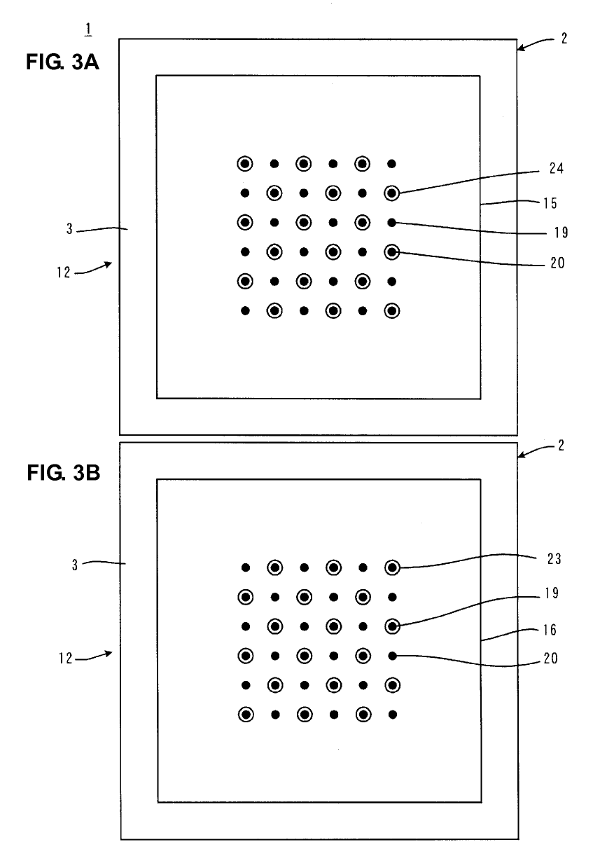

FIGS. 1 to 3B illustrate a layered capacitor 1 according to a preferred embodiment of the present invention. FIG. 1 is a vertical sectional view illustrating the internal structure of the layered capacitor 1. FIGS. 2A to 3B are horizontal sectional views illustrating the internal structure of the layered capacitor 1.

The layered capacitor 1 includes a substantially rectangular-parallelepiped capacitor body 2. The capacitor body 2 has a layered structure including stacked dielectric layers 3 composed of, for example, a dielectric ceramic. Bump-shaped first external terminal electrodes 6, second external terminal electrodes 7, third external terminal electrodes 8, and fourth external terminal electrodes 9, for example, are provided on a first main surface 4 and a second main surface 5 of the capacitor body 2. In FIG. 1, the reference numbers 8 and 9 of the third and fourth external terminal electrodes, respectively, are parenthesized since the third external terminal electrodes 8 and the fourth external terminal electrodes 9 are the first external terminal electrodes 6 and the second external terminal electrodes 7, respectively, in this preferred embodiment.

As shown in FIG. 1, the capacitor body 2 includes first capacitor sections 11 and a second capacitor section 12. The first capacitor sections 11 and the second capacitor section 12 are disposed in a direction along which layers are stacked. Moreover, the second capacitor section 12 is interposed between the first capacitor sections 11 in the layer-stacking direction. As a result, the first capacitor sections 11 are located at ends of the capacitor body 2 in the layer-stacking direction.

Each of the first capacitor sections 11 includes at least a pair of a first internal electrode 13 and a second internal electrode 14 facing each other with one of the dielectric layers 3 interposed therebetween so as to form electrostatic capacitance. The second capacitor section 12 includes at least a pair of a third internal electrode 15 and a fourth internal electrode 16 facing each other with one of the dielectric layers 3 interposed therebetween so as to form electrostatic capacitance.

In this preferred embodiment, a plurality of pairs of the first internal electrodes 13 and the second internal electrodes 14 and a plurality of pairs of the third internal electrodes 15 and the fourth internal electrodes 16 are provided for the capacitor sections in order to form larger electrostatic capacitances.

As described above, FIGS. 2A to 3B are horizontal sectional views illustrating the internal structure of the layered capacitor 1. More specifically, FIG. 2A is a cross-sectional view illustrating the internal structure of the first capacitor sections 11 at a section at which a first internal electrode 13 is located, and FIG. 2B is a cross-sectional view illustrating the internal structure of the first capacitor sections 11 at a section where a second internal electrode 14 is located. Moreover, FIG. 3A is a cross-sectional view illustrating the internal structure of the second capacitor section 12 at a section where a third internal electrode 15 is located, and FIG. 3B is a cross-sectional view illustrating the internal structure of the second capacitor section 12 at a section where a fourth internal electrode 16 is located.

The first capacitor sections 11 further include first via conductors 17 and second via conductors 18, and the second capacitor section 12 further includes third via conductors 19 and fourth via conductors 20. As shown in FIG. 1, the third via conductors 19 and the fourth via conductors 20 are directly connected to the first via conductors 17 and the second via conductors 18, respectively, so as to be used in common in this preferred embodiment.

Each of the first via conductors 17 extends through a desired number of the dielectric layers 3 so as to electrically connect the first internal electrodes 13 to each other, and electrically connect the first internal electrodes 13 and the first external terminal electrode 6. Although the first via conductors 17 also pass through the second internal electrodes 14, the first via conductors 17 are electrically insulated from the second internal electrodes 14 since gaps 21 are provided in the vicinity of portions at which the first via conductors 17 pass through.

Each of the second via conductors 18 extends through a desired number of the dielectric layers 3 so as to electrically connect the second internal electrodes 14 to each other, and electrically connect the second internal electrodes 14 and the second external terminal electrode 7. Although the second via conductors 18 also pass through the first internal electrodes 13, the second via conductors 18 are electrically insulated from the first internal electrodes 13 since gaps 22 are provided in the vicinity of portions at which the second via conductors 18 pass through.

The third via conductors 19 extend through a desired number of the dielectric layers 3 so as to electrically connect the third internal electrodes 15 to each other, and electrically connect the third internal electrodes 15 and the third external terminal electrodes 8. Since the third via conductors 19 and the first via conductors 17 are used in common in this preferred embodiment, the third via conductors 19 are electrically connected to the third external terminal electrodes 8 via the first via conductors 17. Although the third via conductors 19 also pass through the fourth internal electrodes 16, the third via conductors 19 are electrically insulated from the fourth internal electrodes 16 since gaps 23 are provided in the vicinity of portions at which the third via conductors 19 pass through.

The fourth via conductors 20 extend through a desired number of the dielectric layers 3 so as to electrically connect the fourth internal electrodes 16 to each other, and electrically connect the fourth internal electrodes 16 and the fourth external terminal electrodes 9. Since the fourth via conductors 20 and the second via conductors 18 are used in common in this preferred embodiment, the fourth via conductors 20 are electrically connected to the fourth external terminal electrodes 9 via the second via conductors 18. Although the fourth via conductors 20 also pass through the third internal electrodes 15, the fourth via conductors 20 are electrically insulated from the third internal electrodes 15 since gaps 24 are provided in the vicinity of portions where the fourth via conductors 20 pass through.

The layout of only a portion of the first external terminal electrodes 6 to the fourth external terminal electrodes 9 on the main surfaces 4 and 5 of the capacitor body 2 are shown in FIG. 1. As is clear from the description above, the first external terminal electrodes 6 to the fourth external terminal electrodes 9 are disposed at locations corresponding to those of the first via conductors 17 to the fourth via conductors 20, respectively. That is, the first external terminal electrodes 6 to the fourth external terminal electrodes 9 are located at planar locations corresponding to those of the first via conductors 17 to the fourth via conductors 20, respectively, shown in FIGS. 2A to 3B.

In the above-described preferred embodiment, the resonant frequency of the first capacitor sections 11 and that of the second capacitor section 12 differ from each other, and the resonant frequency of the first capacitor sections 11 is greater than that of the second capacitor section 12. In this preferred embodiment, in particular, the number of the first via conductors 17 and the second via conductors 18 in the first capacitor sections 11 and the number of the third via conductors 19 and the fourth via conductors 20 in the second capacitor section 12 differ from each other such that the resonant frequencies are different. More specifically, the total number of the third via conductors 19 and the fourth via conductors 20 provided per dielectric layer 3 included in the second capacitor section 12 is less than the total number of the first via conductors 17 and the second via conductors 18 provided per dielectric layer 3 included in the first capacitor sections 11. With this arrangement, the resonant frequency of the first capacitor sections 11 is increased as compared to that of the second capacitor section 12. The difference in the resonant frequencies can be obtained by changing the material, the pattern, and/or the number of layers of the internal electrodes 13 to 16, for example.

Moreover, in this preferred embodiment, the total number of the first via conductors 17 and the second via conductors 18 provided per dielectric layer 3 included in the first capacitor sections 12 is greater than the total number of the third via conductors 19 and the fourth via conductors 20 provided per dielectric layer 3 included in the second capacitor section 12. With this arrangement, the ESL of the first capacitor sections 11 can be reduced as compared to that of the second capacitor section 12.

Furthermore, in this preferred embodiment, the first external terminal electrodes 6 and the second external terminal electrodes 7 are alternately disposed. With this arrangement, paths of currents flowing from positive electrodes to negative electrodes can be further shortened, and magnetic fluxes can be more effectively canceled. Thus, the ESL in the first capacitor sections 11 can be further reduced.

In addition, in this preferred embodiment, the ESR per dielectric layer 3 formed by a pair of the third internal electrode 15 and the fourth internal electrode 16, the dielectric layer 3 interposed therebetween, the third via conductors 19, and the fourth via conductors 20 included in the second capacitor section 12 is greater than that per dielectric layer 3 formed by a pair of the first internal electrode 13 and the second internal electrode 14, the dielectric layer 3 interposed therebetween, the first via conductors 17, and the second via conductors 18 included in the first capacitor sections 11. In particular, in this preferred embodiment, the total number of the third via conductors 19 and the fourth via conductors 20 included in the second capacitor section 12 is less than the total number of the first via conductors 17 and the second via conductors 18 included in the first capacitor sections 11 such that the ESRs are different. In order to increase the ESR per dielectric layer 3 in the second capacitor section 12 as compared to that in the first capacitor sections 11, materials having higher resistivity can be used for the third via conductors 19 and/or the fourth via conductors 20, or the diameters of the third via conductors 19 and/or the fourth via conductors 20 can be reduced.

Accordingly, the layered capacitor 1 has a high ESR characteristic obtained by the second capacitor section 12 and a low ESL characteristic obtained by the first capacitor sections 11. Thus, the layered capacitor 1 provides both a low ESL and a high ESR.

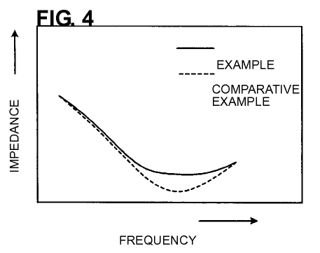

FIG. 4 illustrates frequency-impedance characteristics of a layered capacitor according to a preferred embodiment of the present invention (solid line) and a layered capacitor according to a comparative example outside the scope of the present invention (dashed line) including only a first capacitor section and no second capacitor section.

As shown in FIG. 4, the slope of the impedance characteristic of the layered capacitor according to the comparative example is relatively steep since the ESR is reduced with the ESL, whereas the slope of the impedance characteristic of the layered capacitor according to the preferred embodiment of the present invention is relatively flat since the ESL is reduced and the ESR is increased at the same time.

In FIG. 1, a mounting surface 31 provided by, for example, a wiring board is indicated by an imaginary line. A plurality of conductive lands 32 are provided on the mounting surface 31, and the first external terminal electrodes 6 to the fourth external terminal electrodes 9 are electrically connected to the corresponding conductive lands 32 by soldering, for example.

According to the above-described mounting structure, the layered capacitor 1 is mounted on the mounting surface while the capacitor body 2 is disposed such that one of the first capacitor sections 11 is closer to the mounting surface 31 than the second capacitor section 12 is to the mounting surface 31. In this mounting arrangement, the paths of currents flowing from the first external terminal electrodes 6 to the second external terminal electrodes 7 via the first internal electrodes 13 and the second internal electrodes 14 and those flowing from the second external terminal electrodes 7 to the first external terminal electrodes 6 via the second internal electrodes 14 and the first internal electrodes 13 are shortened. Therefore, the low ESL characteristic obtained by the first capacitor sections 11 can be advantageously utilized, and the high ESR characteristic and the low ESL characteristic of the layered capacitor 1 is maintained in this mounting arrangement.

Moreover, since the second capacitor section 12 is interposed between the two first capacitor sections 11 in the layer-stacking direction and the first external terminal electrodes 6 to the fourth external terminal electrodes 9 are provided on both the first main surface 4 and the second main surface 5 of the capacitor body 2, the vertical orientation of the capacitor body 2 does not need to be taken into account. Therefore, the above-described advantages can be obtained when the second main surface 5 faces the mounting surface 31 as shown in FIG. 1 or when the first main surface 4 faces the mounting surface 31 (not shown).

Preferred embodiments of the present invention has been described with reference to the drawings. However, various modifications are possible within the scope of the present invention.

For example, the number of lamination layers defined by the internal electrodes, the number and the locations of the via conductors, or the number and the locations of the external terminal electrodes can be flexibly changed within the scope of the present invention.

Moreover, the third via conductors 19 and the fourth via conductors 20 can be separated from the first via conductors 17 and the second via conductors 18, respectively. Furthermore, the third external terminal electrodes 8 and the fourth external terminal electrodes 9 can be separated from the first external terminal electrodes 6 and the second external terminal electrodes 7, respectively.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A layered capacitor comprising:
a capacitor body having a layered structure including a plurality of stacked dielectric layers; and
first, second, third, and fourth external terminal electrodes provided on two main surfaces of the capacitor body; wherein
the capacitor body includes two first capacitor sections and a second capacitor section, the first capacitor sections being located at ends of the capacitor body in a layer-stacking direction and the second capacitor section being interposed between the first capacitor sections in the layer-stacking direction;
each of the first capacitor sections includes at least a pair of a first internal electrode and a second internal electrode facing each other with one of the dielectric layers interposed therebetween so as to generate electrostatic capacitance, first via conductors extending through a desired number of the dielectric layers so as to electrically connect the first internal electrode and the first external terminal electrode while the first via conductors are electrically insulated from the second internal electrode, and second via conductors extending through a desired number of the dielectric layers so as to electrically connect the second internal electrode and the second external terminal electrode while the second via conductors are electrically insulated from the first internal electrode;
the second capacitor section includes at least a pair of a third internal electrode and a fourth internal electrode facing each other with one of the dielectric layers interposed therebetween so as to form electrostatic capacitance, third via conductors extending through a desired number of the dielectric layers so as to electrically connect the third internal electrode and the third external terminal electrodes while the third via conductors are electrically insulated from the fourth internal electrode, and fourth via conductors extending through a desired number of the dielectric layers so as to electrically connect the fourth internal electrode and the fourth external terminal electrodes while the fourth via conductors are electrically insulated from the third internal electrode;
a resonant frequency of the first capacitor sections is greater than a resonant frequency of the second capacitor section;
the total number of the third and fourth via conductors provided per dielectric layer included in the second capacitor section is less than the total number of the first and second via conductors provided per dielectric layer included in the first capacitor sections; and
an equivalent series resistance per dielectric layer provided by the pair of third and fourth internal electrodes, the dielectric layer interposed therebetween, and the third and fourth via conductors included in the second capacitor section is greater than an equivalent series resistance per dielectric layer provided by the pair of first and second internal electrodes, the dielectric layer interposed therebetween, and the first and second via conductors included in the first capacitor sections.

2. The layered capacitor according to claim 1, wherein
at least one of the third via conductors and the fourth via conductors is directly connected to at least one of the first via conductors and the second via conductors, respectively, so as to be used in common; and
at least one of the third external terminal electrodes and the fourth external terminal electrodes is also at least one of the first external terminal electrodes and the second external terminal electrodes.

3. The layered capacitor according to claim 1, wherein the first and second external terminal electrodes are alternately disposed.

4. A mounting structure with which the layered capacitor according to claim 1 is mounted on a mounting surface, wherein the capacitor body is arranged such that one of the first capacitor sections is closer to the mounting surface than the second capacitor section is to the mounting surface.

5. The layered capacitor according to claim 2, wherein the at least one of the third via conductors that is directly connected to the at least one of the plurality of first via conductors so as to be used in common extend from the one of the two main surfaces to the other main surface of the capacitor body, and the at least one of the fourth via conductors that is directly connected to the at least one of the plurality of second via conductors so as to be used in common extend from the one of the two main surfaces to the other main surface of the capacitor body.

6. The layered capacitor according to claim 2, wherein the at least one of the third via conductors that is directly connected to the at least one of the first via conductors so as to be used in common are located at a central portion of the plurality of dielectric layers, and the at least one of the fourth via conductors that is directly connected to the at least one of the second via conductors so as to be used in common are located at a central portion of the plurality of dielectric layers.
